(19) United States
(12) Patent Application Publication
(10) Pub. No.: US 2002/0131514 A1
(43) Pub. Date: Sep. 19, 2002

(54) Waveform diversity for communication using pulse decoding

(76) Inventors: Jason Wee Peng Ng, Singapore (SG); Yuen Sam Kwok, Singapore (SG); Kin Mun Lye, Singapore (SG); Jurianto Joe, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/805,824

(22) Filed: Mar. 13, 2001

(51) Int. Cl. H04L 27/00

(52) U.S. Cl. 375/259

(57) ABSTRACT

A communication technique includes mapping an information character to two or more subsymbol waveforms to produce an analog waveform. The two or more subsymbol waveforms define the information character. Alternatively, robustness can be achieved wherein each subsymbol waveform represents the information character, so that the information character is redundant in the analog waveform. The likelihood of success in the subsequent decoding of such a waveform to produce the information character is increased due to the redundancy.

### CROSS REFERENCE TO RELATED APPLICATIONS

This application is related to U.S. application Ser. No. 09/429,527 for METHOD AND APPARATUS FOR GENERATING PULSES FROM ANALOG WAVEFORMS, filed Oct. 28, 1999 and to concurrently filed and co-owned U.S. application Ser. No.______ (Attorney Docket No. 020568-000600US), for “METHOD AND APPARATUS TO RECOVER DATA FROM PULSES”, both of which are owned by the Assignee of the present invention and herein incorporated by reference for all purposes.

### BACKGROUND OF THE INVENTION

This invention relates generally to communication between a transmitter and a receiver via a channel. It has application to telecommunications, recording, data storage, and control.

Diversity methods are commonly used in conventional telecommunication systems to enhance robustness of the systems. Methods such as time diversity and spatial diversity are familiar principles for those who practice in the telecommunication field.

With the development of electronic technologies, it has now been determined that transmission of radio frequency signals at the frequency of modulation is both possible and practical over a broad spectrum, from subaudio frequencies to microwave frequencies. However, heretofore, there has not been a modulation and demodulation technology which takes advantage of this capability.

### SUMMARY OF THE INVENTION

According to the invention, a method and apparatus for transmitting information includes providing an encoding alphabet from which information characters comprising the transmitted information are selected. For at least one information character, first and second waveforms are produced and combined to generate a third waveform. The third waveform is transmitted. For at least another information character, a fourth waveform of a single cycle is generated and transmitted.

The invention is applicable not only to electromagnetic transmission and reception, it can be used with any energy form, whether or not coherent.

### BRIEF DESCRIPTION OF THE DRAWINGS

The teachings of the present invention can be readily understood by considering the following detailed description in conjunction with the accompanying drawings:

FIG. 1 is a block diagram of a communication system according to the invention;

FIG. 2 illustrates an embodiment of an arbitrary analog waveform used to represent a symbol which exhibits the waveform diversity of the present invention;

FIG. 3 shows an example of the pulses corresponding to the waveforms shown in FIG. 2;

FIG. 4 illustrates another embodiment of an arbitrary analog waveform used to represent a symbol which exhibits the waveform diversity of the present invention;

FIGS. 5 and 6 show performance data, illustrating an advantage of the present invention; and

FIG. 7 shows in block diagram format an illustrative circuit for producing the waveforms shown in FIG. 5.

### DESCRIPTION OF THE SPECIFIC EMBODIMENTS

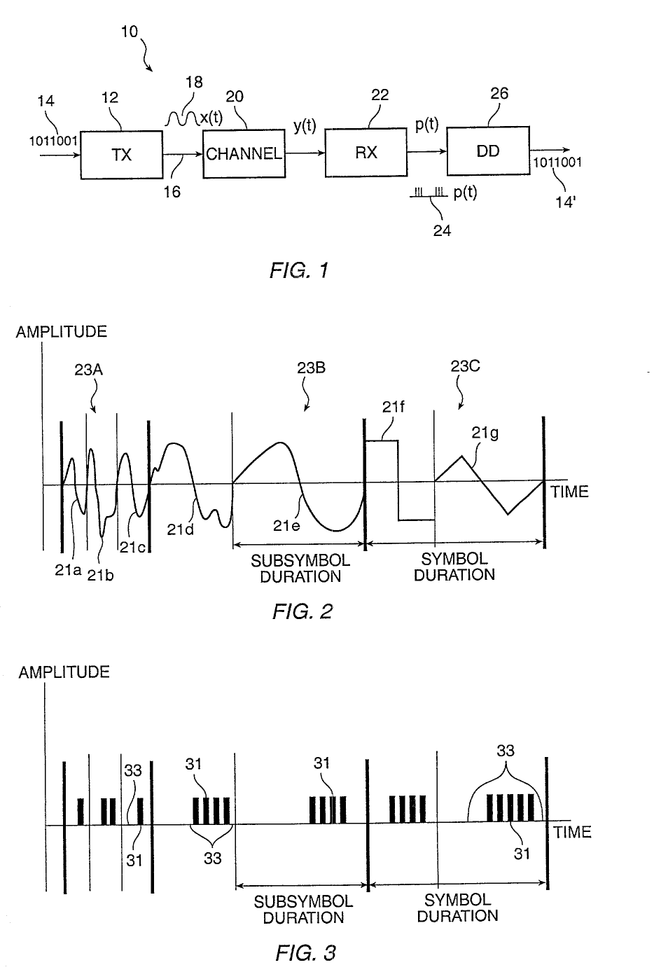

FIG. 1 is a block diagram of a communication system 10 according to the invention. The system 10 comprises a transmitter 12 and a receiver 22 coupled via a channel 20. The transmitter 12 receives a data stream 14 and transmits, via an output 16 an analog output waveform 18 as a source signal, represented by x(t) in the form of a sequence of symbols. The channel 20 is representative of all impairments to the transmitted source signal x(t), including noise, between the transmitter 12 and the receiver 22. The channel 20 yields a received signal y(t) to the receiver 22. Hence, the transmission mapping function is given by:

y(t)=f(x(τ), t) (1)

The receiver 22 according to the invention produces an output in the form of groups of pulses or P(t), as hereinafter explained, that are applied to a decision device 26. The decision device 26 recovers a representation of the data stream 14 as a data stream 14′. This is done for example by counting pulses in each group and mapping the pulse counts of each group of pulses to the character established by the system character set. Other techniques are disclosed in commonly owned, co-pending, concurrently filed U.S. application Ser. No.______ (Attorney Docket No. 020568-000600US), entitled “Method and Apparatus to Recover Data From Pulses”, incorporated herein by reference for all purposes.

Referring to FIG. 2, a closer examination of the analog output waveform 18 shown in FIG. 1 reveals that the analog output waveform comprises a sequence of symbol waveforms 23A-23C. Each symbol waveform consists of one or more subsymbol waveforms. A subsymbol waveform is an analog waveform that carries an information character (symbol) of a subsymbol character set. An information character (symbol) represented by a symbol waveform that consists of more than one subsymbol waveforms is determined after each subsymbol waveform is converted to a group of pulses. Subsequently, these groups of pulses generated in response to the subsymbol waveforms representing the symbol waveform can be utilized to recover the symbol using the techniques disclosed in, but not limited to, commonly owned, co-pending, concurrently filed U.S. application Ser. No.______ (Attorney Docket No. 020568-000600US), entitled “Method and Apparatus to Recover Data From Pulses”.

In accordance with an embodiment of the invention, one or more of the symbol waveforms further comprise plural subsymbol waveforms 21a-21g, a technique herein referred to as “waveform diversity.” As can be seen in FIG. 2, a symbol waveform may be comprised of a concatenation of a different combination of subsymbol waveforms. In effect, the symbol waveform is segmented into plural “subsymbols”, each subsymbol having a corresponding subsymbol waveform. For example, the symbol waveform 23A comprises the concatenation of the subsymbol waveforms 21a-21c. The symbol period (or symbol duration) is equal to the sum of the periods of the subsymbol waveforms which constitute the symbol waveform.

Each constituent subsymbol waveform 21a-21g of a symbol waveform 23A-23C can be any arbitrary analog waveform. The arbitrary analog waveform may be a sinusoid, a ramp, a sawtooth, a square wave, an arbitrary asymmetric waveform, or a waveform having a shape selected to be optimized to the a priori characteristics of the channel 20. Each subsymbol waveform comprises one cycle of the arbitrary waveform. Each subsymbol waveform is coded with information, for example by anything which affects the shape, including but not limited to amplitude, frequency, slope, phase and any combination thereof.

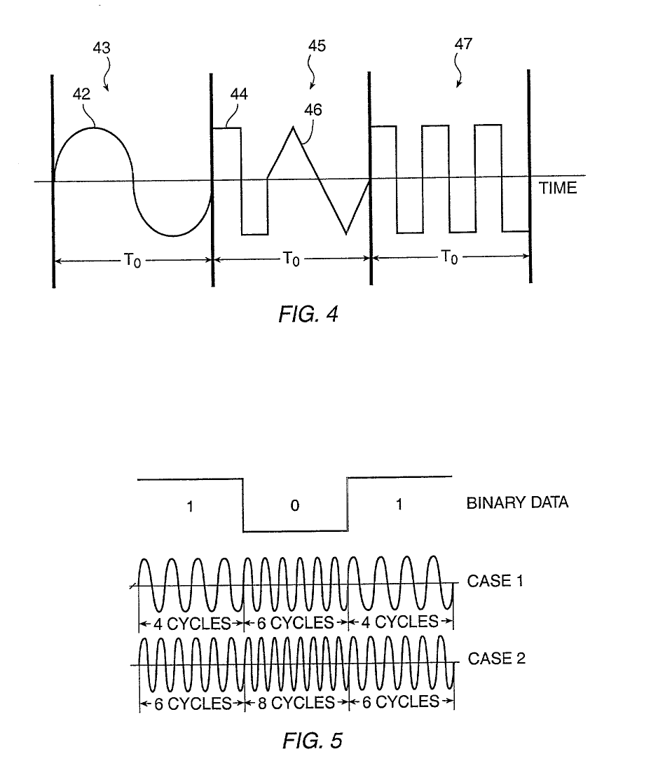

Not every symbol waveform necessarily comprises plural subsymbol waveforms. Some symbol waveforms may comprise one cycle of a single waveform, in which case the subsymbol waveform and the symbol waveform are the same, see for example symbol waveform 42 in FIG. 4. Other symbol waveforms, in accordance with the invention, may comprise some combination of subsymbol waveforms According to the invention, a symbol waveform may comprise two or more cycles of the same subsymbol waveform; see for example symbol waveform 47 in FIG. 4. A symbol waveform may comprise one cycle each of two or more subsymbol waveforms, such as the symbol waveforms 23A-23C illustrated in FIG. 2. In the most general case, a symbol waveform may comprise one or more cycles each of two or more subsymbol waveforms.

The symbol waveforms 23A-23C are encoded by the transmitter 12 to produce the analog output waveform 18 (FIG. 1). For some symbol waveforms, the transmitter may map an information character of a character set or alphabet of values to a single waveform shape to be applied to the channel 20. The simplest character set is the binary set “one” and “zero” or “true” and “false” but there is no limitation on the number of characters in the character set other than practical limitations imposed by natural laws about the number of bits per symbol. The more characters in a character set, the lower is the robustness for a given energy level in the presence of noise. The symbol duration shown in FIG. 2 determines also the rate at which the symbol is transmitted and it is called a symbol rate. Similarly, the subsymbol duration determines the subsymbol rate. The subsymbol rate is higher than the symbol rate. Furthermore, the symbol rate is typically relatively slow with respect to the pulse train extracted therefrom. Other information characters may be processed according to the present invention to produce symbol waveforms. The information character is mapped to two or more subsymbol waveforms 21 to yield a symbol waveform, such as the symbol waveforms 23A-23C shown in FIG. 2. The analog output waveform 18 (FIG. 1) for each such symbol waveform comprises a combination of two or more subsymbol waveforms. Preferably, the combination of subsymbol waveforms will be selected to take into account the effects of the channel 20 on the analog output waveform in order to optimize reception by the receiver 22.

FIG. 3 shows how each of the subsymbol waveforms 21a-21g is decoded by the receiver 22 to produce a corresponding pulse train comprising a distinct group of pulses 31. Each group of pulses 31 is separated by silence periods 33. The duration of a subsymbol waveform after processing by the receiver 22 is equal to the duration of silence periods plus the duration of the pulse train. Typically, the duration of a silence period between two groups of pulses is greater than the time between individual pulses within a group. For a symbol waveform that comprises a single constituent subsymbol, the corresponding pulse train comprises one group of pulses. For a symbol waveform, the corresponding pulse train comprises one more corresponding groups of pulses, one group of pulses for each constituent subsymbol waveform.

The information character (symbol) represented by a symbol waveform or a subsymbol waveform is readily achieved by a reverse-mapping process based on the various parameters of the pulse train corresponding to that symbol waveform or subsymbol waveform. For example, the number of groups of pulses within a symbol can be one of a number of factors for reverse-mapping. The number of pulses in the group of pulses corresponding to each subsymbol waveform, the duration of the silence periods between groups of pulses constituting a symbol waveform, and the total number of pulses within a group of pulses are other factors that can also be used. In general, any of a number of combinations of parameter may be used for the reverse-mapping. By optimizing the combination of these parameters in the decoding process to convert these groups of pulses to the information character it represents, a robust pulse decoding communication system can be attained. Circuits used to decode groups of pulses are disclosed in, but not limited to, commonly owned, co-pending, concurrently filed U.S. application Ser. No.______ (Attorney Docket No. 020568-000600US), entitled “Method and Apparatus to Recover Data From Pulses”.

When the communication system requires a constant symbol duration for all characters, waveform diversity can also be applied. Subsymbol waveforms with different subsymbol durations can be combined to form symbol waveforms having a constant symbol duration. Following is an illustrative example of such an embodiment of the invention wherein constant symbol duration for all symbol waveforms is realized.

Referring to FIG. 4, there are three characters being represented by three symbol waveforms 43, 45, and 47. Each symbol waveform is to be constructed by one, or a combination, of three different subsymbol waveforms 42, 44, and 46. As can be seen, the subsymbol waveforms have different subsymbol durations. The subsymbol waveforms 42, 44, and 46 are sinusoid, square wave, and triangular wave, respectively. In this illustration, symbol waveform 43 comprises one cycle having a period To of subsymbol waveform 42 having a period To. Symbol waveform 45 comprises a concatenation of one cycle each of subsymbol waveform 44 and subsymbol waveform 46, in a way that the period of the symbol waveform 45 is To. Symbol waveform 47 comprises three cycles of subsymbol waveform 44, in a way that the period of symbol waveform 47 is To.

An aspect of this embodiment of the invention is that for the symbol waveforms, the corresponding group of pulses for each subsymbol waveform constituting the symbol waveform can be treated as representing multiple instances of the same information character, or can be considered together to define the information character. This aspect of the invention can be explained in conjunction with FIG. 4. Consider the symbol waveform 45, for example. One may, by a priori decision, define subsymbol waveform 44 and subsymbol waveform 46, each to represent an information character, say binary bit ‘0’. Consequently, symbol waveform 45 would represent two occurrences of binary bit ‘0’. The significance of doing this will be explained below in connection with FIG. 5.

Alternatively, one may decide a priori that the information character ‘0’ will be defined by a symbol waveform (e.g., waveform 45) that comprises one cycle of subsymbol waveform 44 and one cycle of subsymbol waveform 46. Here, the symbol waveform 45 represents only one instance of binary bit ‘0’, whereas under the foregoing definition, symbol waveform 45 represents two instances of binary bit ‘0’; i.e., the ‘0’ bit is redundant. Following is a discussion describing an advantage for the redundancy.

### Experimental Results

To show that waveform diversity is capable of enhancing the robustness of the system, an experiment was carried out using the configuration shown in FIG. 1. A binary data stream 14 was provided by a Pseudo Random Binary Sequence (PRBS, not shown) to simulate a source of data to be transmitted according to the invention. The data rate was set at 0.2 Mbps (megabits per second). Two subsymbol waveforms were selected for this particular experiment. Equal amplitude sinusoidal waveforms were used in transmitter 12 as subsymbol waveforms to symbolize the binary data. Thus, the symbol for binary ‘1’ was represented by concatenating N-cycles of a first subsymbol waveform of a given frequency. The symbol for binary ‘0’ was represented by the concatenation of M-cycles of a second subsymbol waveform of a frequency different from the first subsymbol waveform.

Referring to FIG. 5, in the experiment two cases were compared. In Case 1, the first subsymbol waveform was a 0.8 MHz sinusoid and the second waveform was a 1.2 MHz sinusoid. The symbol for binary ‘1’ comprised four cycles of the 0.8 MHz subsymbol waveform. The symbol for binary ‘0’ comprised six cycles of the 1.2 MHz subsymbol waveform.

In Case 2, the first subsymbol waveform was a 1.2 MHz sinusoid and the second waveform was a 1.6 MHz sinusoid The symbol for binary ‘1’ comprised six cycles of the 1.2 MHz subsymbol waveform. The symbol for binary ‘0’ comprised eight cycles of the 1.6 MHz subsymbol waveform. Case 2 uses more subsymbol waveforms to represent each bit. Therefore, this case is said to exhibit greater waveform diversity than in Case 1.

The binary data stream 14 was fed into the transmitter 12 and converted to produce an analog waveform 18. Analog waveforms were produced for each case 1 and 2. The waveforms were transmitted to an Additive White Gaussian Noise (AWGN) circuit, which simulated a transmission channel 20 having noise characteristics typical of real-life transmission media.

At the receiver 22, the incoming waveforms y(t) were filtered using a Band Pass Filter with 0.7 MHz bandwidth. The filtered waveforms were converted to groups of pulses 24. The groups of pulses were fed to a decoder 26 configured according to the present invention, and decoded thereby to recover the ‘transmitted’ binary data stream 14′. The test conditions for both Case 1 and Case 2 were maintained to be the same and the decoding algorithm used to convert the groups of pulses 24 to produce the binary data stream was also maintained for each case.

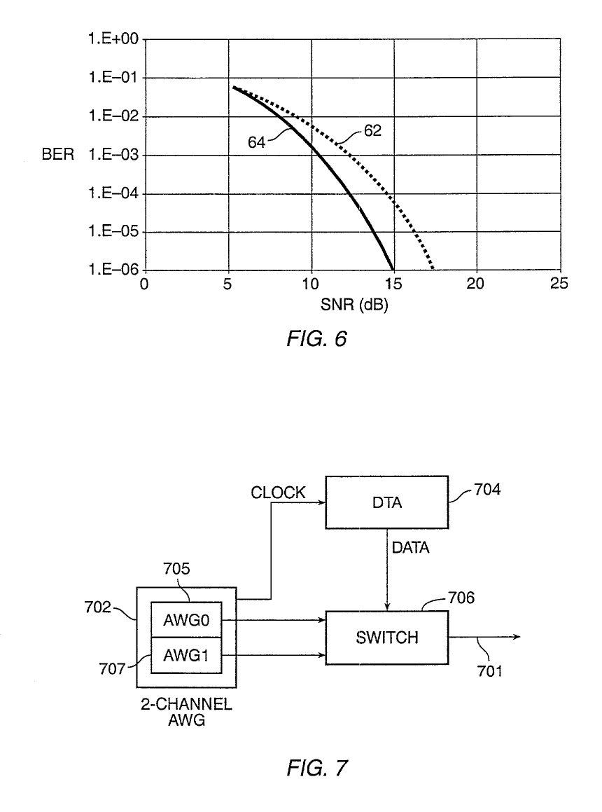

The recovered binary data stream 14′ was compared to the original binary data stream 14, to determine how many errors occurred during the transmission, for various levels of noise power. The results of the comparison are shown in FIG. 6. As can be seen, the ratio of transmitted waveform power to noise power is reflected on the axis as Signal to Noise Ratio (SNR), and the Bit Error Rate (BER) is reflected on the ordinate.

Trace 62 represents the BER performance as a function of SNR for Case 1. Trace 64, likewise, represents the BER performance as a function of SNR for Case 2. As described above, Case 2 uses two additional cycles to represent each bit ‘1’ and ‘0’ as compared to Case 1. As expected, Case 2 shows as much as 2 dB improvement in BER through the AWGN channel simulation. If more cycles are added for each symbol, further improvement in performance can be expected. Of course, doing so decreases the symbol rate. However, the increase in robustness might be more desirable in a particular situation than a high symbol rate.

Channel Arbitrary Waveform Generator 705 (AWG0) is programmed to produce 4 cycles of a 0.8 MHz sinusoidal waveform. The second channel 707 (AWG1) is programmed to produce 6 cycles of a 1.2 MHz sinusoidal waveform. To synchronize the alternation of waveforms shown in FIG. 5, a 0.2 MHz clock signal is transmitted from the generator 702 to a Digital Transmission Analyzer (DTA) 704, at the beginning of each waveform cycle of AWG0 and AWG1. The random binary data is generated in 704 and clocked out and fed into the enable line of a switch 706. The switch is configured to function as a single-pole-double-throw switch. If the data contains binary 1 and 0, the switch can be configured to respond to the 1's and 0's; for example, by coupling the output of AWG0 to the switch output 701 for 1's and the output of AWG1 to the output 701 for 0's. A similar configuration can be realized for Case 2. In general, it can be seen that using appropriate waveform generators, the arbitrary signals illustrated in FIGS. 2 and 4 can be produced.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Although the present invention has been described in terms of specific embodiments, it should be apparent to those skilled in the art that the scope of the present invention is not limited to the described specific embodiments.

Further, it should be recognized that invention can be realized using various combinations of hardware and software. The present invention may be implemented only in hardware or only in software or using combinations thereof, depending on performance goals and other criteria not relevant to the practice of the invention.

The specification and drawings are, accordingly, to be regarded in an illustrative rather than a restrictive sense. It will, however, be evident that additions, subtractions, substitutions, and other modifications may be made without departing from the broader spirit and scope of the invention as set forth in the claims.

What is claimed is:

1. A method for transmitting comprising:
providing an encoding alphabet comprising a plurality of information characters;
producing at least a first waveform associated with a first information character;
producing at least a second waveform associated with said first information character;
producing a third waveform by combining said first and second waveforms, thereby defining a symbol; and
transmitting said third waveform.

2. The method according to claim 1 wherein said third waveform comprises one cycle of said first waveform and one cycle of said second waveform.

3. The method according to claim 1 further including producing a fourth waveform representing a second information character.

4. The method according to claim 3 wherein said third waveform and said fourth waveform have the same period.

5. The method according to claim 3 wherein said third and fourth waveforms have the same period.

6. The method according to claim 1 wherein said first waveform and said second waveform each represents said first character information.

7. The method according to claim 6 wherein said first waveform and said second waveform are identical waveforms.

8. The method according to claim 6 wherein said first waveform and said second waveform have different periods.

9. The method according to claim 1 wherein said first waveform and said second waveform together represent said first character information.

10. The method according to claim 1 further including producing at least a fourth waveform, wherein said producing a third waveform includes combining said fourth waveform with said first and second waveforms.

11. The method according to claim 10 wherein said first waveform, said second waveform, and said fourth waveform are different waveforms, which together represent said first information character.

12. A method for communication between a transmitter and a receiver comprising:
generating an analog waveform including generating at least a first waveform corresponding to an information character of an encoding alphabet, said first waveform defining a symbol, said first waveform having a first period; and
transmitting, from said transmitter to said receiver, a source signal characterized by said analog waveform,
said generating at least a first waveform including:
generating a second waveform having a period less than said first period;
generating a third waveform having a period less than said first period, said second and third waveforms representing said information character; and
combining said second and third waveforms to produce said first waveform.

13. The method according to claim 12 wherein said first waveform comprises one cycle of said second waveform and one cycle of said third waveform.

14. The method according to claim 12, wherein said generating an analog waveform further includes generating a fourth waveform corresponding to another information character of said encoding alphabet, wherein a period of said fourth waveform is equal to said first period.

15. The method according to claim 12, wherein said second and third waveforms, each is selected from the group consisting of sinusoidal, ramp, asymmetric, sawtooth, square, and channel-optimized waveforms.

16. The method according to claim 12, wherein said second and third waveforms are identical, so that said information character is redundant in said first waveform to increase robustness of said source signal.

17. The method according to claim 12 wherein said second and third waveform together represent said information character.

18. The method according to claim 12 wherein said second waveform represents said information character and said third waveform represents said information character, so that said information character occurs more than once in said first waveform to increase robustness of said source signal.

19. The method according to claim 18 wherein said second waveform and said third waveform are different waveforms.

20. The method according to claim 12 wherein said second waveform and said third waveform have different periods, the sum of which is equal to said first period.

21. The method according to claim 12 wherein said periods of second waveform and said third waveform each is one-half of said first period.
